(19) United States
(12) Patent Application Publication
(10) Pub. No.: US 2006/0039041 A1
(43) Pub. Date: Feb. 23, 2006

(54) Image forming control system, image forming apparatus, external device, image forming control program, and computer-readable storage medium storing the image forming control program

(76) Inventors: Masao Saeda, Yamatokoriyama-shi (JP); Nobuya Kishi, Yamatokoriyama-shi (JP); Yasuhiro Nakai, Soraku-gun (JP)

Correspondence Address: EDWARDS & ANGELL, LLP, P.O. BOX 55874, BOSTON, MA, 02205, US

(21) Appl. No.: 11/203,082

(22) Filed: Aug. 12, 2005

(30) Foreign Application Priority Data
Aug. 19, 2004 (JP) 2004-239937

(51) Int. Cl. H04N 1/40

(52) U.S. Cl. 358/471

(57) ABSTRACT

An image forming control system includes: a sending section (sending means) 47 for sending a thumbnail, generated in accordance with specific image data, whose information amount is smaller than the specific image data, to a mobile terminal (external device) 2; a receiving section (receiving means) 46 for receiving from the mobile terminal 2 an image forming condition under which an image based on the specific image data is formed; and an image forming instruction section (instruction means) 43 for sending to an image forming section 13 an image forming instruction to form the image based on the specific image data in accordance with the image forming condition.

This Nonprovisional application claims priority under U.S.C. § 119(a) on Patent Application No. 2004/239937 filed in Japan on Aug. 19, 2004, the entire contents of which are hereby incorporated by reference.

### FIELD OF THE INVENTION

The present invention relates to an image forming control system for forming an image by inputting an image forming condition with a mobile terminal or the like for example.

### BACKGROUND OF THE INVENTION

Recently, as image forming apparatus such as electronic copying machines, not only a conventional analog type but also a digital type have been widely used. Further, with development of a digital image processing technique, full-color digital copying machines for reproducing a color image with high quality have been produced as commercial products.

Recently, with improvement in the computer performance and decrease in the cost, a network system has been constructed in which peripheral devices are shared in a network, particularly, LAN (Local Area Network) so as to process information sent from a computer.

Further, there is proposed a digital multi-functional device which has not only a function for printing an image read by a reading device but also, for example, a scanning function, a facsimile function, an output function for outputting data sent from a personal computer, and the like.

In case of the multi-functional device having a plurality of functions as a single device in this manner, when someone is inputting an image forming condition, others cannot operate the multi-functional device. That is, while someone is operating the multi-functional device, the multi-functional device is occupied, so that others cannot operate the multi-functional device.

In order to solve such a problem that a device occupied by someone cannot be used by other one who wants to use another function, Japanese Unexamined Patent Publication No. 330371/2002 (Tokukai 2002-330371)(Publication date: Nov. 15, 2002)(Hereinafter, referred to Patent Document 1) proposes the following technique for example.

Specifically, Patent Document 1 discloses such an arrangement that: in a device such as a so-called “puri-kura (instant photo machine to make tiny stickers)”, a photographing process (inputting an image), an editing process, and a printing process are respectively performed at different sections so that it is possible to spend sufficient time in editing an image while improving an efficiency at which the device is used.

Further, Japanese Unexamined Patent Publication No. 361984/2002 (Tokukai 2002-361984)(Publication date: Dec. 18, 2002)(hereinafter, referred to as Patent Document 2) proposes such an arrangement that: a printer having received a print job sends an E-mail with a key code to an operator, and begins printing an image corresponding to the print job in response to a return mail sent from the operator, thereby enforcing the security and keeping the operability.

However, according to the foregoing conventional techniques, although it is possible to decrease a time in which the image forming apparatus is occupied, there occur various problems.

According to the arrangement disclosed in Patent Document 1, a printed image is edited so as to output thus edited image. According to this arrangement, in case where the photographing process is performed before completing previous edition, it is impossible to perform subsequent edition until the previous edition is completed. Further, the edition is performed by someone operating a machine for editing the image, so that it is difficult to reduce a time in which the edition device is occupied.

Further, according to the arrangement disclosed in Patent Document 2, it is possible to control beginning of job through a mobile device, but it is impossible to control the content of the job. That is, the arrangement disclosed in Patent Document 2 is merely such that a command to begin image forming is given by using a mobile phone, and the arrangement does not change an image forming condition under which an image is formed. Further, the arrangement disclosed in Patent Document 2 is made so as to enforce the security, and an E-mail with a key code that has been sent to a mobile phone includes no content for performing image forming. Thus, an operator selects data for performing image forming in accordance with only a title or the like, so that an image corresponding to undesired data may be formed.

Further, according to the conventional techniques, in case of editing scanned print data or previously acquired print data sent from an information device such as a personal computer and stored in a reserving section (a storage medium such as a memory, a hard disk, or the like) of the image forming apparatus, only the image forming apparatus allows the edition, and the image forming apparatus is occupied by someone editing the print data, so that a next user cannot use the image forming apparatus. As a result, a working rate of the image forming apparatus drops. Further, in case of editing the print data, an editing function is limited depending on a type of a display section of the image forming apparatus, so that an unintentionally edited image may be printed.

### SUMMARY OF THE INVENTION

An object of the present invention is to provide an image forming control system which allows a time in which an image forming apparatus is occupied to be reduced by using an external device and allows an operator to more precisely set an image forming condition.

In order to achieve the foregoing object, an image forming control system according to the present invention, which controls an image forming section for forming an image based on image data in accordance with an image forming condition, includes: a sending section for sending display image data, generated in accordance with specific image data, whose information amount is smaller than the specific image data, to an external device; a receiving section for receiving from the external device the image forming condition under which an image based on the specific image data is formed; and an instruction section for sending to the image forming section an image forming instruction to form the image based on the specific image data in accordance with the image forming condition that has been received by the receiving section.

According to the foregoing arrangement, the display image data whose information amount is smaller than the specific image data is sent to the external device, so that it is possible to reduce the information amount sent to the external device. On this account, since the information amount sent to the external device is small, even a mobile terminal which cannot treat a large amount of information due to limitations such as an outer shape (size) and a function (portability) can favorably send the display image data. Further, an operator of the external device can set the image forming condition for forming an image based on the specific image data, in accordance with which the display image data has been generated, while checking the display image data. That is, the operator can set the image forming condition, under which the image based on the original specific image data is formed, while checking the display image data, so that it is possible to confirm a final output condition, thereby more precisely setting the image forming condition. Particularly, in case of changing an order in which images are formed or changing a direction in which images are formed, the operator sets the image forming condition while checking the display image data, so that it is possible to confirm a condition under which images are actually formed, thereby easily forming images in a state desired by the operator.

Further, according to the foregoing arrangement, the image based on the specific image data is formed in accordance with the image forming condition generated by the external device, so that a time in which the image forming deice is occupied by someone inputting the image forming condition can be cut unlike the arrangement in which the operator inputs the image forming condition by operating an operation section of the image forming apparatus.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram schematically showing an arrangement of an image forming apparatus provided with an image forming control system according to an embodiment of the present invention.

FIG. 2 is a block diagram illustrating how information is exchanged between the image forming apparatus having the image forming control function (image forming control system) and a communication device via a network.

FIG. 3 is a side view schematically showing an arrangement of the image forming apparatus.

FIG. 4 is a state transition diagram for illustrating a series of processes in which: a thumbnail is sent from the image forming apparatus to a mobile terminal, and an image forming condition under which an image based on specific image data is formed is obtained from the mobile terminal, and an image is formed in accordance with the image forming condition.

FIG. 5(a) and FIG. 5(d) illustrate how contents in a storage section of the image forming apparatus are changed by setting the image forming condition. FIG. 5(b) and FIG. 5(c) illustrate contents displayed in the mobile terminal.

FIG. 6 is a block diagram showing how information is exchanged among the image forming apparatus, the server, and the communication device (mobile terminal).

FIG. 7 is a block diagram illustrating an arrangement in which the image forming apparatus and a server are provided separately from each other.

FIG. 8 is a state transition diagram for illustrating a series of processes in which: a thumbnail is sent to the communication device, and an image based on the specific image data is formed in accordance with the image forming condition sent from the communication device.

FIG. 9 illustrates a scalable image.

### DESCRIPTION OF THE EMBODIMENTS

One embodiment of the present invention is described as follows. That is, an image forming control system according to the present invention is arranged so that: when receiving an image forming instruction from an external device, the image forming control system sends display image data, generated from specific image data, to the external device, and receives from the external device an image forming condition of the specific image data in accordance with which the display image data has been generated, the image forming condition being generated in accordance with the display image data, and the image forming control system causes an image forming section (image forming apparatus) to form an image in accordance with the image forming condition.

Note that, the following description explains an image forming apparatus in which the image forming control function and the image forming function are integrated to each other. However, it may be so arranged that the image forming control function and the image forming function are provided separately from each other. Further, the image forming apparatus may have not only the image forming function but also various functions such as a scanner function, a facsimile function, and the like for example. Further, examples of the image forming apparatus are a printing machine, a copying machine, a printer, and the like.

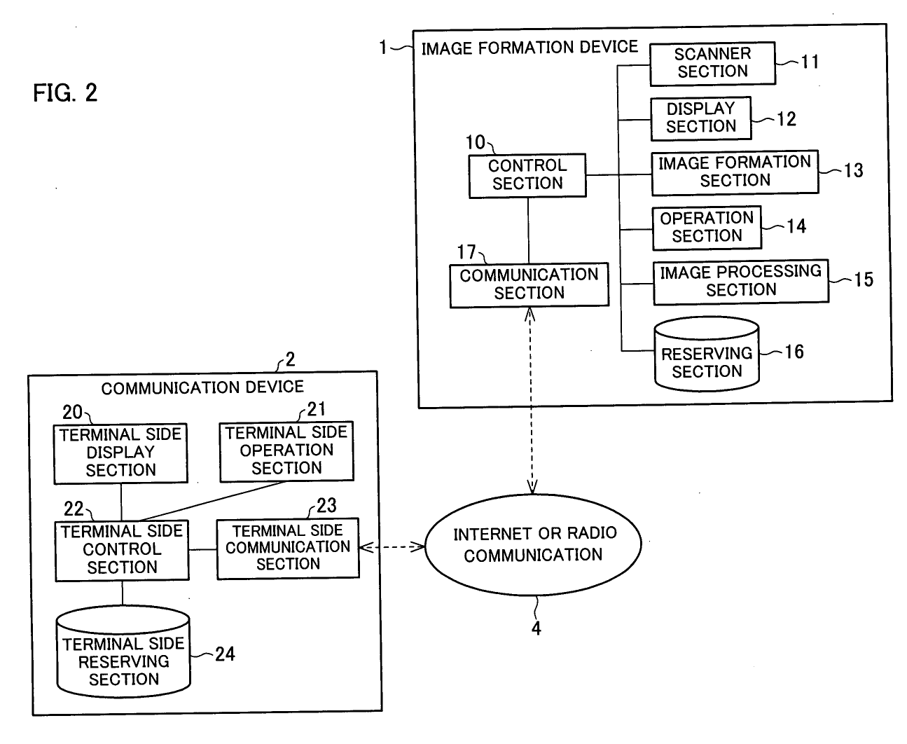

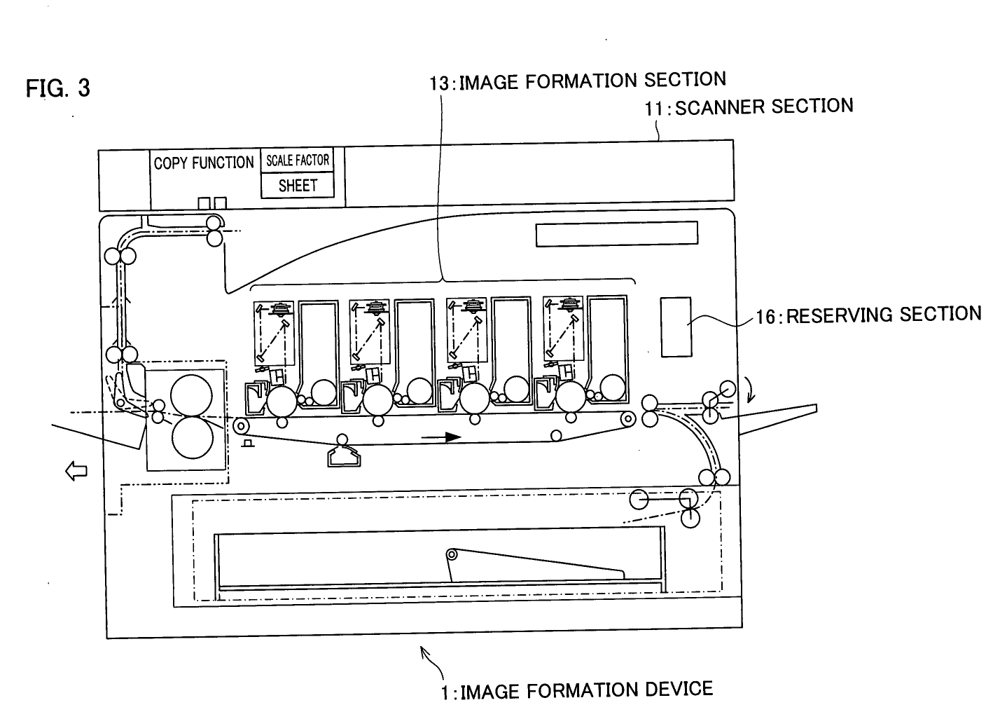

FIG. 2 is a block diagram illustrating an arrangement in which information is exchanged between an image forming apparatus 1 having an image forming function (image forming control system) and a communication device 2 via a network 4. Note that, in the following description, the image forming apparatus 1 having the image forming control system is explained. FIG. 3 is a side view schematically showing an arrangement of the image forming apparatus 1.

As shown in FIG. 2 and FIG. 3, in case of forming an image by using the image forming apparatus 1 and the communication device 2 (external device), the image forming apparatus 1 includes a communication section 17, a control section 10 (image forming control system), a scanner section 11 (image supplying device), a reserving section 16 (image supplying device), a display section 12, an image forming section 13 (image forming means), an operation section 14, ad an image processing section 15.

The scanner section 11 is an image scanning device, and obtains image data (hereinafter, referred to merely as an image) by scanning a document. The reserving section 16 stores the image scanned by the scanner section 11. Further, the reserving section 16 may store not only the image scanned by the scanner section 11 but also an image sent from the outside for example. The image forming section 13 forms an image in accordance with an image forming instruction sent from the control section 10. The communication section 17 exchanges information with the communication device 2 via the network 4 such as the Internet, a radio communication, and the like for example. The display section 12 displays various information (for example, warning, a current situation, and the like). Further, in case of forming an image by using only the image forming apparatus 1 for example, the image forming condition is displayed in the display section 12. The operation section 14 is used to set the image forming condition for forming an image or to operate the image forming apparatus 1. The image processing section 15 processes the image reserved (stored) in the reserving section 16. Specifically, the image processing section 15 processes the image reserved (stored) in the reserving section 16 in forming an image with the image forming section 13. The control section 10 controls operations of the communication section 17, the scanner section 11, the display section 12, the image forming section 13, the operation section 14, the image processing section 15, and the reserving section 16. The control section 10 corresponds to the image forming control system according to the present invention. Further, the control section 10 generates a thumbnail of the specific image data whose image is to be formed, and sends the thumbnail to the communication device 2. Note that, the control section 10 will be described later.

While, the communication device 2 (mobile terminal 2) includes a terminal side operation section 21, a terminal side communication section 23, a terminal side reserving section 24, a terminal side display section 20, and a terminal side control section 22.

The terminal side operation section 21 is used to operate the communication device 2. Further, in case of sending the image forming condition, under which an image based on the specific image data is formed, from the communication device 2 to the image forming apparatus 1, the terminal side operation section 21 is used to input (set) the image forming condition. The terminal side display section 20 displays various information. In case of inputting the image forming condition for example, the image forming condition is displayed in the terminal side display section 20. Further, the terminal side display section 20 displays the thumbnail received from the image forming apparatus 1. The terminal side communication section 23 exchanges information with the image forming apparatus 1 via the network 4 such as the Internet, a radio network, and the like for example. The terminal side reserving section 24 reserves the thumbnail or various information received via the terminal side communication section 23.

Further, in the present embodiment, it is possible to send the image forming command from the communication device 2 to the image forming apparatus 1. More specifically, the communication device 2 receives from the image forming apparatus 1 or the server 3 the thumbnail of the specific image data whose image is to be formed, and sends to the image forming apparatus 1 the image forming condition of the specific image data that has been generated with reference to the thumbnail. This is described as follows.

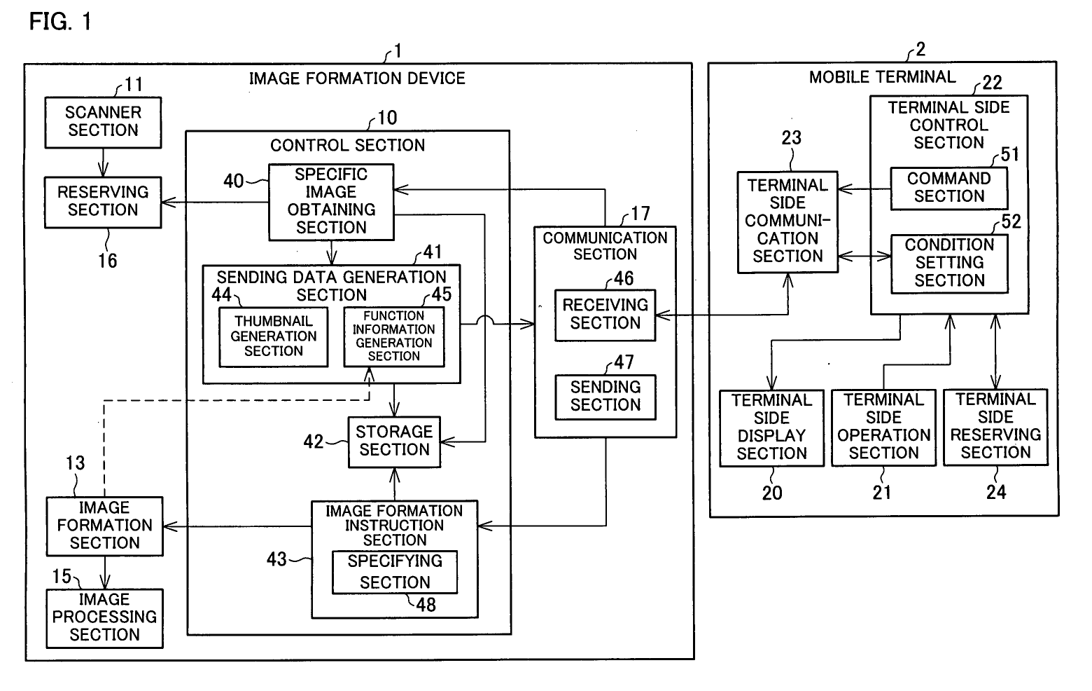

FIG. 1 is a block diagram schematically showing an arrangement of the image forming apparatus 1 provided with the image forming control system according to the present embodiment. The image forming apparatus 1 can exchange information with the mobile terminal 2 (communication device 2).

Here, the image forming control system (control section 10) according to the present embodiment is described. The control section 10 generates an image forming instruction so that the image forming section 13 forms an image scanned by the scanner section 11 or an image stored in the reserving section 16.

Specifically, as shown in FIG. 1, the control section 10 includes a specific image obtaining section 40 (obtaining means), a sending data generating section 41, and an image forming instruction section 43. Further, the control section 10 may include a storage section 42 (storage means) as required.

The specific image obtaining section 40 obtains image data (i.e., specific image data) based on a specific condition from images stored in the reserving section 16 and the storage section 42 or images scanned by the scanner section 11. Specifically, the specific image obtaining section 40 obtains the specific image data in accordance with information (an obtaining condition) sent from the mobile terminal 2.

The sending data generating section 41 generates information, which is to be sent to the mobile terminal 2, in accordance with the specific image data obtained by the specific image obtaining section 40. Specifically, the sending data generating section 41 includes a thumbnail generating section 44 (generation means). Further, the sending data generating section 41 includes a function information generating section 45 (function obtaining means) as required.

The thumbnail generating section 44 generates display image data (hereinafter, referred to as a thumbnail), whose information amount is smaller than the specific image data, in accordance with the specific image data obtained by the specific image obtaining section 40. The thumbnail is an image displayed in the terminal side display section 20 of the mobile terminal 2, and serves as an image to be browsed. Thus, it may be so arranged that an image per se of the thumbnail cannot be edited. As a data format (data standard) of the thumbnail, any format may be adopted, but it is particularly preferable to adopt an SVG standard. The SVG standard will be described later.

The function information generating section 45 generates function information (function information concerning functions of the image forming section 13 or functions given to the image forming apparatus 1 so as to perform image forming) which is unique to the image forming apparatus 1 (or the image forming section 13). Examples of the function information unique to the image forming apparatus 1 are: information, concerning functions of the image forming apparatus 1, which indicates (i) whether or not it is possible to perform processes such as a stapling process, a punching process, and the like, (ii) a maximum sheet size on which an image can be formed, and the like; and (iii) information concerning a condition under which the image forming apparatus 1 can form an image.

Further, the sending data generating section 41 generates sending data, which is to be sent to the mobile terminal 2, in accordance with the thumbnail generated by the thumbnail generating section 44 and the function information generated by the function information generating section 45 as required.

The communication section 17 includes a receiving section 46 (receiving means) and a sending section 47 (sending means). The receiving section 46 obtains information from the outside such as the mobile terminal 2 and the like. The sending section 47 sends information to the outside such as the mobile terminal 2 and the like.

The image forming instruction section 43 gives an image forming instruction to the image forming section 13 in accordance with the image forming condition received from the mobile terminal 2 via the receiving section 46. Note that, the image forming instruction section 43 may include a specifying section 48. The specifying section 48 specifies the specific image data, corresponding to the image forming condition, from a plurality of images stored in a storage section 42 described later, in accordance with the image forming condition that has been received from the mobile terminal 2.

Next, the mobile terminal 2 which can send and receive information to and from the image forming apparatus 1 is described as follows. The mobile terminal 2 includes a terminal side communication section 23, a command section 51, and a condition setting section 52.

The command section 51 generates an image forming command so as to command the image forming apparatus 1 to form an image in accordance with the specific image data. The terminal side communication section 23 receives information sent from the image forming apparatus 1, and sends information (the image forming command and the image forming condition) to the image forming apparatus 1.

The condition setting section 52 sets the image forming condition of the specific image data. Further, the operator of the mobile terminal 2 operates the condition setting section 52 with reference to the thumbnail received from the image forming apparatus 1, thereby setting the desired image forming condition. Examples of the image forming condition are: a direction in which images are formed; a size of a recording material on which an image is formed; a scaling factor at which an image indicated by the specific image data is formed; whether image forming is performed or not in case where the specific image data is constituted of plural images; an order in which images are formed; and the like.

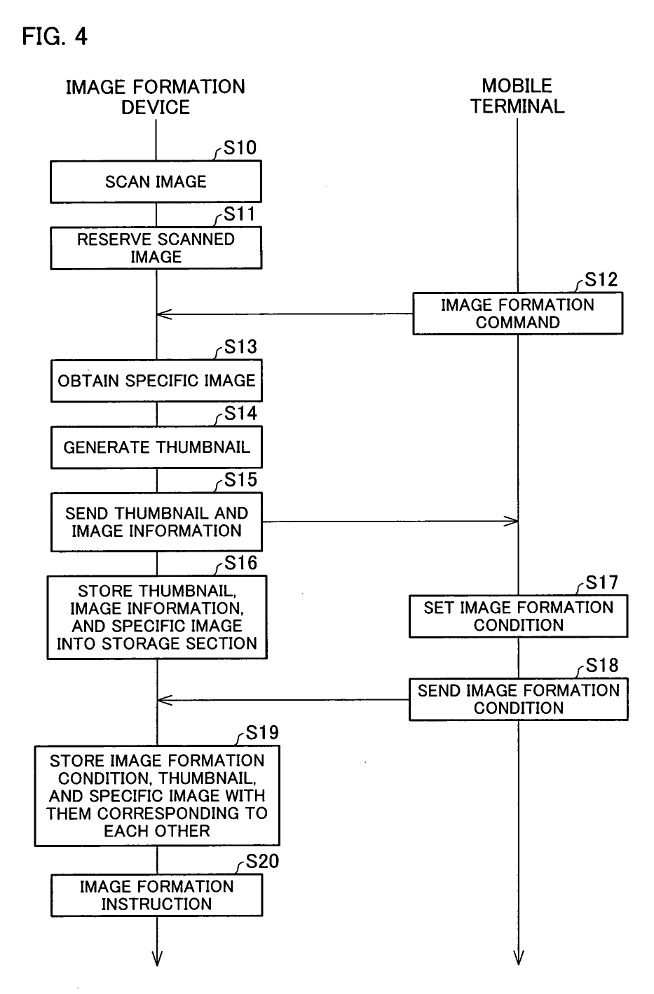

Here, with reference to FIG. 4, the following description explains a series of processes in which: the thumbnail is sent from the image forming apparatus 1 to the mobile terminal 2, and the image forming condition of the specific image data is obtained by the image forming apparatus 1 from the mobile terminal 2, and the image forming apparatus 1 forms an image in accordance with the image forming condition.

First, the operator obtains the specific image data by scanning a document with the scanner section 11 (S10). Thus scanned specific image data is reserved (stored) in the reserving section 16 of the image forming apparatus 1 (S11).

Thereafter, the operator who operates the mobile terminal 2 so as to form an image based on the specific image data scanned in the image forming apparatus 1 (the operator may be the operator of the image forming apparatus 1 or may be different from the operator of the image forming apparatus 1) sends an image forming command to the image forming apparatus 1 (S12).

When the image forming apparatus 1 receives the image forming command from the mobile terminal 2, the specific image obtaining section 40 of the control section 10 obtains the specific image data, corresponding to the image forming condition, from the image data reserved in the reserving section 16 (S13). Note that, in case where single image data is reserved in the reserving section 16, the image data serves as the specific image data. Further, in case where plural sets of image data are reserved in the reserving section 16, the operator sends an image forming command which specifies the specific image data. Further, it may be so arranged that: a list or the like of image data reserved in the reserving section 16 is sent to the mobile terminal 2 in advance, and the operator sends the image forming command for forming an image based on the specific image data, in accordance with the list.

Next, the specific image obtaining section 40 which has obtained the specific image data sends the specific image data to the sending data generating section 41. Further, the sending data generating section 41 generates the thumbnail in accordance with the specific image data (S14). The thumbnail is a vector image, and its data amount is smaller than that of the original specific image data. Next, the sending data generating section 41 extracts image information, concerning the specific image data (e.g., a size, a direction, and the like of the specific image data), from the specific image data in accordance with which the thumbnail has been generated. Further, the sending data generating section 41 sends the thumbnail and the image information, that have been generated, to the mobile terminal 2 via the communication section 17 (S15). Note that, the sending data generating section 41 causes the storage section 42 to store the specific image data, the thumbnail and the image information, that have been generated, with the specific image data, the thumbnail, and the image information corresponding to each other (S16).

The mobile terminal 2 having received the thumbnail and the image information displays the information in the terminal side display section 20. Further, with reference to the thumbnail and the image information, the operator uses the condition setting section 52 so as to set the image forming condition for forming an image based on the specific image data (S17). Note that, how the image forming condition is set is specifically described later. Further, the operator sends the image forming condition, that has been set, to the image forming apparatus 1 (S18).

The communication section 17 of the image forming apparatus 1 which has received the image forming condition sends the image forming condition to the image forming instruction section 43. Further, the specifying section 48 of the image forming instruction section 43 specifies the specific image data, whose image is to be formed, from the image data stored in the storage section 42, in accordance with the image forming condition that has been received. Further, the image forming instruction section 43 causes the storage section 42 to store the image forming condition, the specific image data, and the thumbnail (and the image information) with the image forming condition, the specific image data, and the thumbnail (and the image information) corresponding to each other (S19). Specifically, the image forming instruction section 43 causes the storage section 42 to store the image forming condition so that the image forming condition corresponds to the specific image data and the thumbnail (and the image information) correspondingly stored in the storage section 42.

Further, the image forming instruction section 43 sends the image forming condition and the specific image data, that have been received, to the image forming section 13, so as to cause the image forming section 13 to form an image. In other words, the image forming instruction section 43 gives an image forming instruction to the image forming section 13 (S20).

In this manner, the image forming condition for forming an image is generated in the mobile terminal 2, and an image based on the specific image data is formed in accordance with the image forming condition.

Note that, in S19, the storage section 42 stores the image forming condition, the specific image data, and the thumbnail with them corresponding to each other. However, in the image forming thereafter, the foregoing step is not necessary in case where an image based on the specific image data is not formed in accordance with the image forming condition stored in the storage section 42. Thus, for example, when the step S19 is not performed and the image forming condition is received, it may be so arranged that: the specific image data is specified from the image data stored in the storage section 42, and thus specified specific image data and the image forming condition are sent to the image forming section 13, thereby forming an image. Further, in the step S20, the specific image data stored in the storage section 42 is used to form an image, but it may be so arranged that, for example, the specific image data stored in the reserving section 16 is read out so as to form an image.

Further, in the step S18, the operator sets the image forming condition of the specific image data with reference to the thumbnail. Here, the following description explains how the display image data and the specific image data are made to correspond to each other. In generating the thumbnail in accordance with the specific image data, the sending data generating section 41 adds the same IDs to both of them. Then, the thumbnail having the ID is sent to the mobile terminal 2. Further, in causing the mobile terminal 2 to set the image forming condition of the specific image data, the same ID as that of the thumbnail having been sent is added to the image forming condition. Further, the image forming condition including the ID is sent to the image forming apparatus 1. The image forming apparatus 1 having received the image forming condition identifies (specifies) the specific image data in accordance with the ID of the image forming condition having been received. That is, the same IDs are given to the specific image data and the thumbnail generated in accordance with the specific image data, and the same ID as that of the thumbnail is set in setting the image forming condition with the mobile terminal 2, thereby specifying the original specific image data in accordance with the ID included in the image forming condition received by the image forming apparatus 1.

Note that, in case where the image forming apparatus 1 stores only single specific image data and the thumbnail for example, even when the ID is not added, it is possible to specify the image forming condition, received from the mobile terminal 2, as the stored specific image data.

Further, in case where the control section 10 includes the image processing section 15 for processing an image based on the image data, it may be so arranged that: the image forming instruction section 43 uses the image processing section 15 so as to process a specific image in accordance with the image forming condition, and then sends the specific image data whose image has been processed to the image forming section 13 so that image forming is performed.

Further, the foregoing description explained the example where: the image data is scanned with the scanner section 11, and the image forming command to form an image based on the specific image data reserved in the reserving section 16 is given, but the arrangement is not limited to the foregoing arrangement. For example, in case of setting an image forming condition of a document image which has not been scanned, it may be so arranged that the control section 10 detects that the image forming command has been received from the mobile terminal 2, and the scanner section 11 scans the document image. In this case, the document image scanned by the scanner section 11 corresponds to the specific image data, so that the specific image obtaining section 40 judges that the image data scanned by the scanner section 11 is the specific image data after receiving the image forming command from the mobile terminal 2.

Further, in case where the image forming command to form an image based on the specific image data after the thumbnail has been generated is given by the mobile terminal 2, the following process may be performed. Specifically, in case where the image forming command to form an image based on the specific image data is received from the mobile terminal 2, the specific image obtaining section 40 performs retrieval so as to find whether the specific image data whose image is to be formed is stored in the storage section 42 or not. The storage section 42 stores the specific image data whose thumbnail has been generated with the specific image data and the thumbnail corresponding to each other. Thus, when the specific image obtaining section 40 found the specific image data, whose image should be formed, from the storage section 42, the specific image obtaining section 40 sends the thumbnail (and the image information), corresponding to the specific image data stored in the storage section 42, to the mobile terminal 2 via the communication section 17. Note that, the foregoing description explained the case in which the specific image obtaining section 40 sends the thumbnail to the mobile terminal 2, but the specific image obtaining section 40 may be arranged so that: for example, after sending the thumbnail corresponding to the obtained specific image data to the sending data generating section 41, the sending data generating section 41 sends the thumbnail. Further, in case where the thumbnail has been stored in the storage section 42, the storage section 42 stores also a previous image forming condition for forming an image based on the specific image data corresponding to the thumbnail. In this case, not only the thumbnail but also the previous image forming condition is sent to the mobile terminal 2, so that the operator setting the image forming condition can set the current image forming condition by setting only a change given to the previous image forming condition.

Further, in case where the sending data generating section 41 is provided with the function information generating section 45 for example, the sending data generating section 41 may send also the function information, generated by the function information generating section 45, when generating the thumbnail from the specific image data and sending the thumbnail to the mobile terminal 2. This case is explained as follows. In case where the image forming section 13 for forming an image is determined, the function information generating section 45 obtains function information, concerning functions of the image forming section 13, from the image forming section 13. Specific examples of the function information are: information, concerning functions of the image forming section 13, which indicates (i) a maximum sheet size on which an image can be formed, (ii) whether or not it is possible to perform a stapling process, and the like; (iii) and information unique to the image forming section 13. Further, in case where the function information obtaining section 45 has obtained the function information, the sending data generating section 41 sends not only the thumbnail (and the image information) but also the function information to the mobile terminal 2. On this account, the operator of the mobile terminal 2 can find a condition, under which the image forming section 13 can perform image forming, in setting the image forming condition.

Further, the mobile terminal 2 can store the thumbnail, the image information, and the function information that have been sent from the image forming apparatus 1. Further, the image forming condition is set in accordance with the thumbnail stored in the mobile terminal 2, and the image forming condition is sent to the image forming apparatus 1.

The foregoing description explained the arrangement in which the reserving section 16 and the storage section 42 are provided separately from each other, but it may be so arranged that a single section is used as both the reserving section 16 and the storage section 42.

Also, the foregoing description explained the example where the mobile terminal 2 gives the image forming command to form an image based on the specific image data stored in the storage section 42, but it may be so arranged that: for example, thumbnails concerning all or plural sets of image data stored in the reserving section 16 or the storage section 42 are sent to the mobile terminal 2, and the operator of the mobile terminal 2 gives an image forming command to form an image based on the desired image data.

Specifically, when the operator of the mobile terminal 2 gives an instruction to request thumbnails of all images stored in the storage section 42 or the reserving section 16, the specific image obtaining section 40 of the image forming apparatus 1 sends all image data stored in the reserving section 16 to the sending data generating section 41 and causes the sending data generating section 41 to generate thumbnails. Further, thus generated thumbnails are sent to the mobile terminal 2. Alternatively, it may be so arranged that the specific image obtaining section 40 obtains thumbnails and a generated image forming condition that are stored in the storage section 42 so as to send the thumbnails and the image forming condition to the mobile terminal 2. Further, these plural thumbnails are reserved in the terminal side reserving section 24 of the mobile terminal 2.

Further, the operator of the mobile terminal 2 uses the thumbnails reserved in the terminal side reserving section 24 so as to set the image forming condition concerning the desired specific image data, and sends the image forming condition to the image forming apparatus 1, thereby forming an image based on the specific image data.

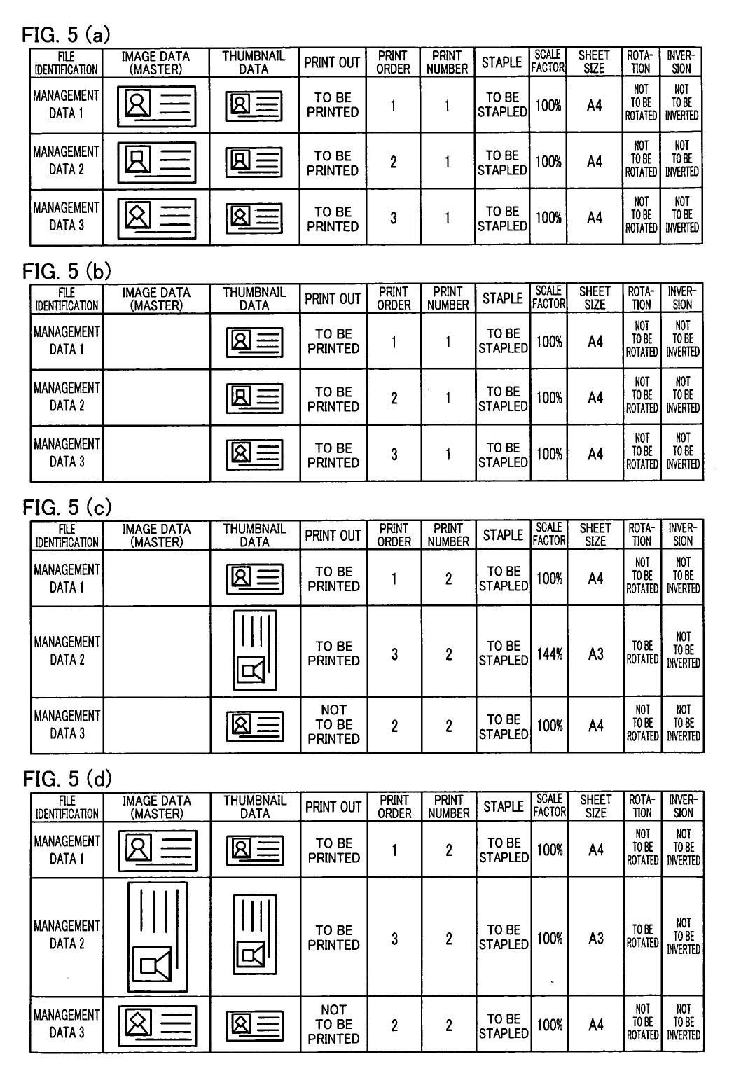

FIG. 5 illustrates how set-up of the image forming condition changes contents of the storage section 42 of the image forming apparatus 1. Next, the set-up of the image forming condition is described as follows with reference to an example of images displayed in the storage section 42 of the image forming apparatus 1 and the mobile terminal 2.

First, when the image forming command is given from the mobile terminal 2, the specific image obtaining section 40 obtains the specific image data stored in the reserving section 16, and then the sending data generating section 41 generates a thumbnail and image information in accordance with the specific image data. The sending data generating section 41 causes the storage section 42 to store the thumbnail, the image information, that have been generated, and the specific image data in accordance with which the thumbnail has been generated, with them corresponding to each other (see FIG. 5(a)). As shown in FIG. 5(a), the storage section 42 stores the specific image data, the thumbnail, and the image information, with them corresponding to each other. Note that, in FIG. 5(a), also the image forming condition is stored, but the image forming storage condition is indicated by a default value which is not set by an operator.

FIG. 5(b) illustrates a condition under which the thumbnail and the image information that have been sent by the sending data generating section 41 are displayed in the mobile terminal 2. As shown in FIG. 5(b), the specific image data itself is not sent to the mobile terminal 2, so that the specific image data is not displayed. Further, in this case, a default image forming condition is displayed in the mobile terminal 2. Thus, as shown in FIG. 5(a) and FIG. 5(b), the image forming condition is not changed.

Thereafter, as shown in FIG. 5(c), the operator of the mobile terminal 2 sets the desired image forming condition. In an example shown in FIG. 5(c), information indicative of (i) whether or not to print an image, (ii) an order in which images are printed, (iii) the number of images to be printed, (iv) a scale-up factor, (v) a sheet size, and (vi) whether or not to perform rotation, are changed. Further, also the thumbnail is changed in accordance with the changed image forming condition. The condition setting section 52 of the mobile terminal 2 changes also a display format of thumbnails in accordance with the image forming condition that has been set.

Further, the image forming condition that has been set by the operator is sent to the image forming apparatus 1. At this time, only the image forming condition may be sent, or both the image forming condition having been set and the thumbnail changed by setting the image forming condition may be sent. In other words, the communication section 17 (receiving section 46) may receive only the image forming condition, or may receive both the image forming condition having been set and the thumbnail changed by setting the image forming condition. Further, when the image forming condition or both the image forming and the thumbnail are received, the image forming instruction section 43 changes contents stored in the storage section 42, or newly stores the image forming condition (see FIG. 5(d)). Specifically, the image forming instruction section 43 changes the specific image data stored in the storage section 42 or newly stores the specific image data, the thumbnail, and the image forming condition with them corresponding to each other, in accordance with the image forming condition that has been received. Further, it may be so arranged that: in case where the image forming condition and the thumbnail (this thumbnail is different from the thumbnail sent from the image forming apparatus 1, and is obtained by changing the original thumbnail in accordance with the image forming condition) are obtained from the mobile terminal 2, the image forming instruction section 43 operates the image processing section 15 so as to process an image based on the specific image data in accordance with the image forming condition, and causes the storage section 42 to store the image forming condition, the thumbnail, and the specific image data whose image has been processed, with them corresponding to each other. The data stored in the storage section 42 in this manner is updated.

Note that, the specific image data, the thumbnail, and the image forming condition, which are stored in the storage section 42 may be updated by a method other than the foregoing method.

Specifically, when the receiving section 46 receives the image forming condition from the mobile terminal 2 for example, the image forming instruction section 43 of the control section 10 operates the image processing section 15 so as to process an image, based on the specific image data corresponding to the image forming condition, in accordance with the image forming condition. Thereafter, the image forming instruction section 43 operates the thumbnail generating section 44 so as to generate the thumbnail in accordance with the specific image data whose image has been processed by the image processing section 15. Further, the image forming instruction section 43 may cause the storage section 42 to store the image forming condition, the specific image data whose image has been processed, and the thumbnail generated in accordance with the specific image data, with them corresponding to each other. That is, it may be so arranged that: the image forming instruction section 43 causes the image processing section 15 to process an image based on the specific image data in accordance with the image forming condition obtained from the mobile terminal 2 and causes the thumbnail generating section 44 to generate the thumbnail in accordance with the specific image data whose image has been processed, and causes the storage section 42 to store them (the thumbnail and the specific image data) and the image forming condition, with them corresponding to each other.

Next, the following description explains an arrangement in which the image forming apparatus 1 and the image forming control system are provided separately from each other. Specifically, the following description explains the aforementioned image forming control system arranged so that the specific image obtaining section 40 and the sending data generating section 41 are separated from the image forming apparatus 1.

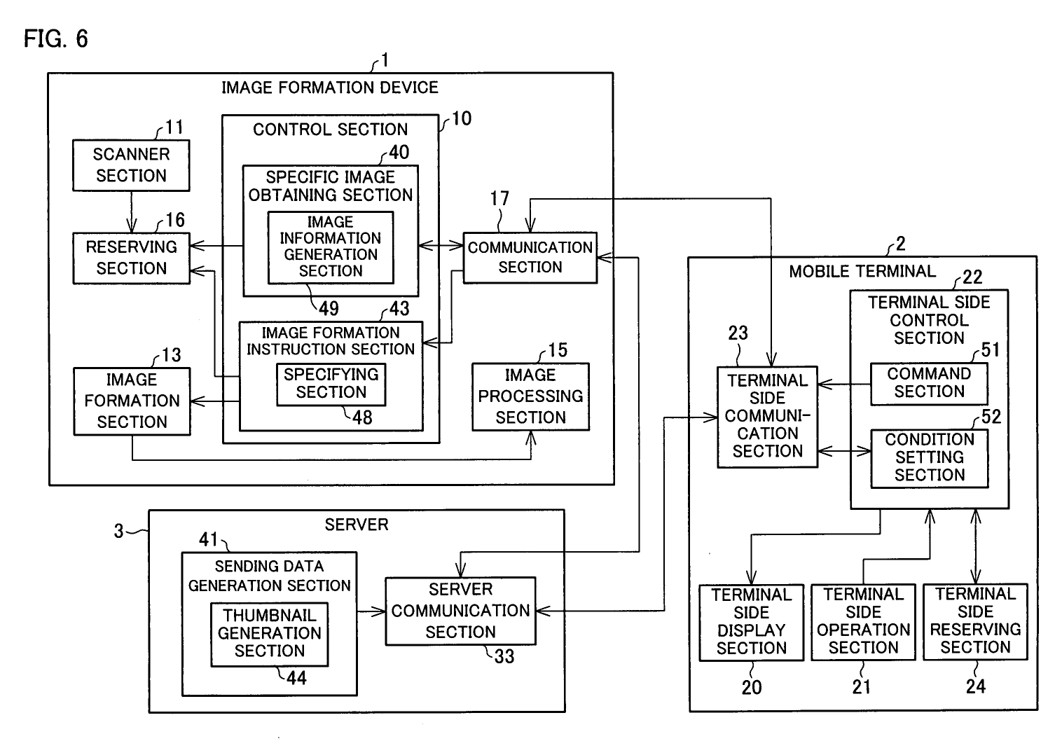

FIG. 6 is a block diagram illustrating an arrangement in which the image forming apparatus 1 and the server 3 are provided separately from each other. The following description explains an arrangement in which sending data including thumbnails sent to a communication device 2 is generated.

As shown in FIG. 6, the image forming control system is constituted of a part of the image forming apparatus 1 and a part of the server 3. Further, information can be exchanged among the communication device 2, the server 3, and the image forming apparatus 1 via a network 4 such as the Internet, a radio communication, or a wired communication for example.

Further, the server 3 includes a server communication section 33, a server display section 30, a server control section 32, a server operation section 31, a server reserving section 34, and a sending data generating section 41. Note that, the image forming apparatus 1 is arranged in the same manner as in the aforementioned arrangement, but is different from the aforementioned arrangement in terms of the control section 10. How the control section 10 and the image forming apparatus 1 are arranged will be described later. Other arrangements are the same as in the foregoing description, and detail description thereof is omitted.

The server communication section 33 exchanges information with the image forming apparatus 1 and the communication device 2 via the network 4. The server display section 30 displays a condition of the server 3, and the server operation section 31 is used to manually operate the server 3. The server reserving section 34 reserves various information and the like received via the server communication section 33. Further, the server control section 32 controls the foregoing arrangements.

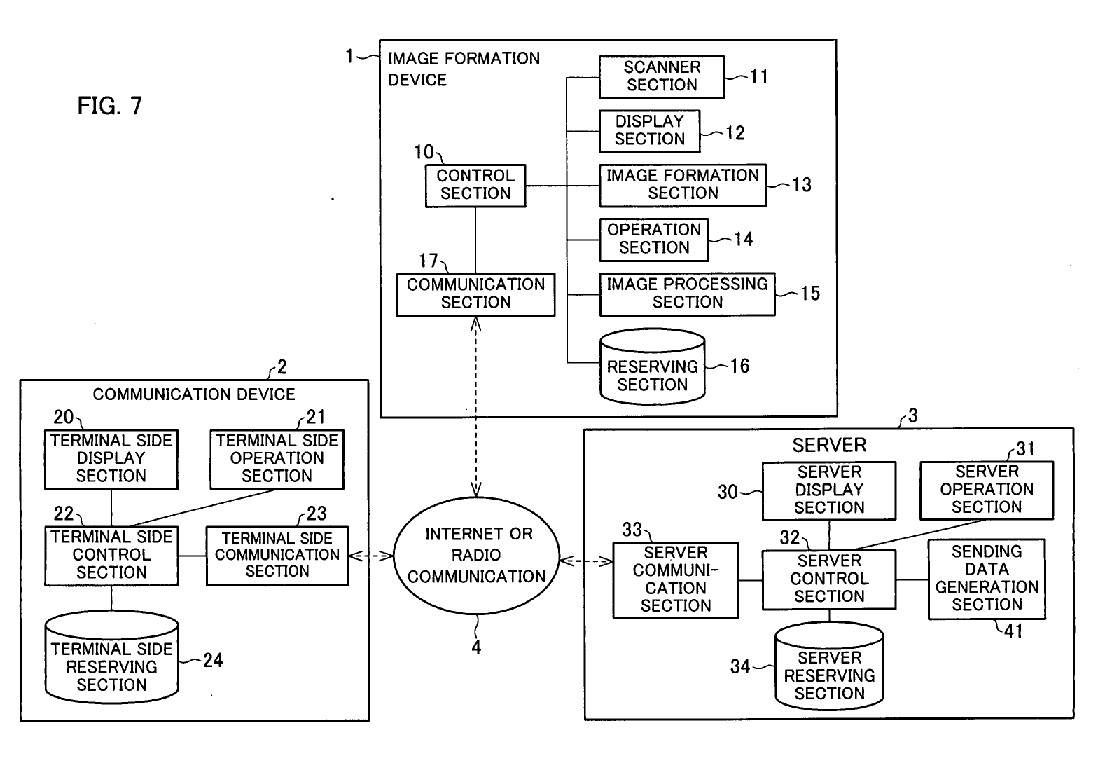

FIG. 7 is a block diagram showing how information is exchanged among the image forming apparatus 1, the server 3, and the communication device 2 (mobile terminal 2).

As shown in FIG. 7, the server 3 is provided with the sending data generating section 41. Further, the specific image obtaining section 40 of the image forming apparatus 1 is provided with an image information generating section 49. The image information generating section 49 generates image information from image data.

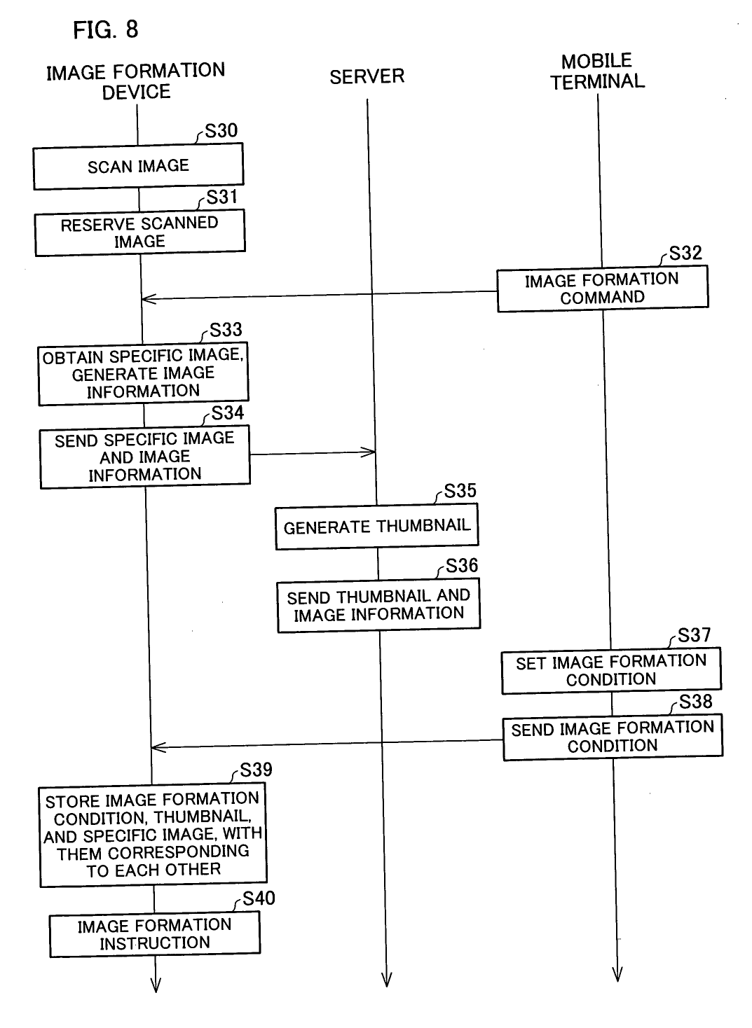

As to the foregoing arrangement, with reference to FIG. 8, the following description explains a series of processes in which: a thumbnail is sent to the communication device 2, and an image based on the specific image data is formed in accordance with the image forming condition sent from the communication device 2.

First, the operator uses the scanner section 11 so as to scan the document, thereby obtaining specific image data (S30). Thus scanned specific image data is reserved (stored) in the reserving section 16 of the image forming apparatus 1 (S31).

Thereafter, the operator who operates the mobile terminal 2 so as to form an image based on the specific image data scanned in the image forming apparatus 1 (the operator may be the operator of the image forming apparatus 1 or may be different from the operator of the image forming apparatus 1) sends an image forming command to the image forming apparatus 1 (S32).

When the image forming command is received from the mobile terminal 2, the specific image obtaining section 40 of the image forming apparatus 1 obtains the specific image data, corresponding to the image forming command, from the image data reserved in the reserving section 16 (S33). At this time, the function information generating section 45 generates image information from the specific image data that has been obtained.

Next, the specific image obtaining section 40 which has obtained the specific image data sends the specific image data and the image information to the sending data generating section 41 of the server 3 (S34).

The sending data generating section 41 having received the specific image data and the image information generates a vector image thumbnail in accordance with the received specific image data (S35). Further, the thumbnail and the image information, that have been generated, are sent to the mobile terminal 2 (S36).

The mobile terminal 2 having received the thumbnail and the image information displays the information in the display section 12. Further, with reference to the thumbnail and the image information, the operator sets the image forming condition for forming an image based on the specific image data (S37). Further, the operator sends the image forming condition and the thumbnail, that have been set, to the image forming apparatus 1 (S38).

The communication section 17 of the image forming apparatus 1 that has received the image forming condition and the thumbnail sends the image forming condition and the thumbnail to the image forming instruction section 43. Further, the specifying section 48 of the image forming instruction section 43 specifies the specific image data, whose image is to be formed, from the image data reserved in the reserving section 16, in accordance with the image forming condition that has been received. Further, the image forming instruction section 43 causes the storage section 42 to store the image forming condition, the specific image data, and the thumbnail (and the image information) with them corresponding to each other (S39).

Further, the image forming instruction section 43 sends the image forming condition and the specific image data, that have been received, to the image forming section 13, so as to cause the image forming section 13 to form an image. In other words, the image forming instruction section 43 gives an image forming instruction to the image forming section 13 (S40).

In this manner, the image forming condition for forming an image is generated in the mobile terminal 2, and an image based on the specific image data is formed in accordance with the image forming condition.

Note that, the foregoing description explained an example where the mobile terminal 2 sends the image forming condition and the thumbnail, but it is not necessarily required to send the thumbnail. Further, in case where the thumbnail is not sent from the mobile terminal 2 to the image forming apparatus 1, a thumbnail generated by the sending data generating section 41 of the server 3 may be sent to the reserving section 16 of the image forming apparatus 1. On this account, it is possible to reserve the specific image data, the thumbnail, and the image forming condition in the reserving section 16 with them corresponding to each other.

Further, in case of sending the function information concerning functions, unique to the image forming section 13, to the mobile terminal 2, a function information generating section (not shown) provided on the image forming apparatus 1 generates function information and sends thus generated function information as well as the specific image data to the sending data generating section 41 of the server 3. Further, the sending data generating section 41 sends the function information as well as the thumbnail to the mobile terminal 2.

Further, the foregoing description explained the case where the operator of the mobile terminal 2 gives the image forming command to the image forming apparatus 1 and sends the image forming condition to the image forming apparatus 1, but it may be so arranged that the image forming command and the image forming condition are sent to the server 3 for example. In this case, the server 3 sends the image forming command and the image forming condition to the image forming apparatus 1.

Further, the foregoing description explained the example where the thumbnail is sent to the mobile terminal 2 via the server 3 and an instruction is given by the mobile terminal to the image forming apparatus 1. However, the instruction (the image forming command and the image forming condition) sent from the mobile terminal 2 may be sent to the server for example. In this case, the image forming command and the image forming condition are forwarded from the server 3 to the image forming apparatus 1.

As described above, the image forming control system according to the present invention, which controls an image forming section (image forming means) 13 for forming an image based on image data in accordance with an image forming condition, includes: a sending section (sending means) 46 for sending a thumbnail, generated in accordance with specific image data, whose information amount is smaller than the specific image data, to a mobile terminal (external device) 2; a receiving section (receiving means) 47 for receiving from the mobile terminal 2 the image forming condition under which an image based on the specific image data used to generate the thumbnail sent to the mobile terminal 2 is formed; and an image forming instruction section (instruction means) 43 for sending to the image forming section 13 an image forming instruction to form the image based on the specific image data in accordance with the image forming condition.

According to the foregoing arrangement, the thumbnail whose information amount is smaller than the specific image data is sent to the mobile terminal 2, so that it is possible to reduce an information amount sent to the mobile terminal 2. On this account, since the information amount sent to the mobile terminal 2 is small, even a mobile terminal which cannot treat a large amount of information due to limitations such as an outer shape (size) and a function (portability) can favorably send the thumbnail. Further, an operator of the mobile terminal 2 can set the image forming condition for forming an image based on the specific image data, in accordance with which the thumbnail has been generated, while checking the received thumbnail. That is, the operator can set the image forming condition of the original specific image data while checking the thumbnail, so that it is possible to confirm a final output condition, thereby more precisely setting the image forming condition. Particularly, in case of changing an order in which images are formed or changing a direction in which an image is formed, the operator sets the image forming condition while checking the thumbnail, so that it is possible to confirm a condition under which an image is actually formed, thereby easily forming an image in a state desired by the operator.

Further, according to the foregoing arrangement, image forming based on the specific image data is performed in accordance with the image forming condition generated in the mobile terminal 2, so that a time in which the image forming deice is occupied by someone inputting the image forming condition can be cut unlike the arrangement in which the operator inputs the image forming condition by operating an operation section of the image forming apparatus.

Note that, it may be so arranged that the foregoing means are provided separately from each other for example. Specifically, for example, the sending section 46, the receiving section 47, and the image forming instruction section 43 may be separated from each other.

It is more preferable to arrange the image forming control system according to the present invention so as to include: a specific image obtaining section (obtaining means) 40 for obtaining the specific image data; and a thumbnail generating section (generation means) 44 for generating a thumbnail, whose information amount is smaller than the specific image data, in accordance with the specific image data that has been obtained.

The specific image obtaining section 40, for example, obtains the specific image data from an image scanning device such as a scanner and image supplying means such as a storage device, e.g., a hard disk, RAM, ROM, a memory, and the like. That is, the specific image obtaining section 40 may obtain the specific image data scanned by the image scanning device, or may obtain specific image data stored in a storage device.

According to the foregoing arrangement, it is possible to generate a thumbnail in accordance with the specific image data whose image should be formed.

It is preferable to arrange the image forming control system according to the present invention so as to include: a storage section (storage means) 42 for storing the thumbnail and the specific image data, in accordance with which the thumbnail has been generated, with the thumbnail and the specific image data corresponding to each other; and a specifying section (specifying means) 48 for specifying the specific image data in accordance with the image forming condition that has been received by the receiving section 47.

According to the foregoing arrangement, the thumbnail and the specific image data in accordance with which the thumbnail has been generated are stored with them corresponding to each other, and the specific image data is specified in accordance with the image forming condition that has been received. On this account, in case where thumbnails generated in accordance with plural sets of specific image data are sent to a single mobile terminal 2 or plural mobile terminals 2 different from each other, it is possible to easily determine specific image data which corresponds to the image forming condition having been received.

It is more preferable to arrange the image forming control system according to the present invention so that the image forming instruction section 43 sends the specific image data whose image should be formed and the image forming instruction based on the image forming condition that has been received.

On this account, both the specific image data and the image forming instruction are sent, so that the image forming section 13 can form an image based on the specific image data in accordance with only the information that has been received.

It is more preferable to arrange the image forming control system according to the present invention so that the sending section 46 sends the thumbnail and image information concerning the specific image data used to generate the thumbnail.

The image information is information indicative of a state of the specific image data in accordance with which the thumbnail has been generated. Specifically, the image information is information unique to the specific image data (e.g., a size and a direction of the specific image data: in case where the specific image data is indicative of plural images, the image information is a page number or the like).

According to the foregoing arrangement, the thumbnail and the image information are sent to the mobile terminal 2, so that the operator setting the image forming condition can generate the image forming condition with reference to not only the thumbnail but also the image information. Thus, it is possible to generate a more precise image forming condition.

It is more preferable to arrange the image forming control system according to the present invention so that: when the thumbnail generating section 44 generates thumbnails constituted of plural pages, the sending section 46 sends the thumbnails, constituted of plural pages, to the mobile terminal 2 in a page count order in which the thumbnails have been generated by the thumbnail generating section 44.

According to the foregoing arrangement, it is possible to send the generated thumbnails constituted of plural pages to the mobile terminal 2 in an order in which the thumbnails have been generated, so that the operator of the mobile terminal 2 can browse the thumbnails in an order in which the thumbnails have been generated by the thumbnail generating section 44. On this account, when the thumbnails are generated in an order of page count of the specific image data constituted of plural pages, the operator can browse the thumbnails in the order of page count.

It is more preferable to arrange the image forming control system according to the present invention so as to include a function specific image obtaining section 40 for obtaining function information (function information concerning functions of the image forming section 13) unique to the image forming section 13, wherein the sending section 46 sends the thumbnail and the function information to the mobile terminal 2.

The function information unique to the image forming section 13 is information, concerning functions of the image forming section 13, which indicates (i) whether or not it is possible to perform processes such as a stapling process, a punching process, and the like, (ii) a maximum sheet size on which an image can be formed, and the like; and (iii) information concerning a condition under which the image forming section 13 can form an image.

According to the foregoing arrangement, the function information unique to the image forming section 13 for forming an image based on the specific image data is obtained, and the function information as well as the thumbnail is sent. On this account, the operator setting the image forming condition sets the image forming condition not merely by referring to the thumbnail but by considering (i) functions of the image forming section 13, (ii) a condition under which the image forming section 13 can perform image forming, (iii) and the like.

It is more preferable to arrange the image forming control system according to the present invention so that the image forming instruction section 43 causes the storage section 42 to store (i) the image forming condition received by the receiving section 47, (ii) the specific image data corresponding to the image forming condition, and (iii) the thumbnail generated in accordance with the specific image data, with the image forming condition, the specific image data, and the thumbnail corresponding to each other, and when the image forming instruction to form the image based on the specific image data corresponding to the image forming condition stored in the storage section 42 is received from the mobile terminal 2, the sending section 46 sends the display image and the image forming condition, each of which corresponds to the image forming instruction of the specific image data, to the mobile terminal 2.

According to the foregoing arrangement, the specific image data, the thumbnail information generated in accordance with the specific image data, and the image forming condition of the specific image data are stored with them corresponding to each other. Thus, when the image forming command to form the image based on the specific image data corresponding to the thumbnail stored in the storage section 42 and/or the image forming condition is given, the thumbnail and the image forming condition that have been generated can be sent to the mobile terminal 2. Thus, in case where the operator performs image forming of the specific image data, whose image has been formed, in accordance with the same image forming condition, it is not necessary to generate a new image forming condition.

It is more preferable to arrange the image forming control system according to the present invention so as to include an image processing section (image processing means) 15 for processing the image based on the specific image data in accordance with the image forming condition, wherein the image forming instruction section 43 causes the image processing section 15 to process the image based on the specific image data in accordance with the image forming condition, and then sends the specific image data whose image has been processed and the image forming instruction to the image forming section 13.

According to the foregoing arrangement, the image forming instruction section 43 sends the specific image data, corresponding to the image forming condition, in accordance with the image forming condition, to the image forming section 13, so that for example even an image forming section 13 having no image processing function can form an image based on the specific image data whose image has been processed.

It is more preferable to arrange the image forming control system according to the present invention so as to include: a storage section 42 for storing information; and an image processing section 15 for processing the image based on the specific image data in accordance with the image forming condition received by the receiving section 46 from the mobile terminal 2, wherein: the receiving section 46 receives the image forming condition from the mobile terminal 2, and the image forming instruction section 43 causes the thumbnail generating section 44 to generate the thumbnail of the specific image data whose image has been processed by the image processing section 15, and causes the storage section 42 to store (i) the image forming condition, (ii) the specific image data whose image has been processed, and (iii) the thumbnail generated by the thumbnail generating section 44, with the image forming condition, the specific image data, and the thumbnail corresponding to each other, and when an image forming instruction to form an image based on the specific image data stored in the storage section 42 is received from the mobile terminal 2, the sending section 47 sends, from among information stored in the storage section 42, the thumbnail and the image forming condition, each of which corresponds to the image forming instruction, to the mobile terminal 2.

It is more preferable to arrange the image forming control system according to the present invention so as to include: a storage section 42 for storing the thumbnail and the specific image data, in accordance with which the thumbnail has been generated, with the thumbnail and the specific image data corresponding to each other; and an image processing section 15 for processing the image based on the specific image data in accordance with the image forming condition, wherein: the receiving section 46 receives the image forming condition and the thumbnail, sent from the sending section 47, whose image has been processed in accordance with the image forming condition, and the image forming instruction section 43 causes the storage section 42 to store (i) the image forming condition, and (ii) the specific image data whose image has been processed by the image processing section, (iii) the thumbnail, received by the receiving section 46, whose image has been processed, with the thumbnail, the image forming condition, and the specific image data corresponding to each other, and when an image forming command to form the image based on the specific image data stored in the storage section 42 is received from the mobile terminal 2, the sending section 47 sends, from among information stored in the storage section 42, the thumbnail and the image forming condition, each of which corresponds to the image forming instruction, to the mobile terminal 2.

According to the foregoing arrangement, an image based on the specific image data is formed in accordance with the image forming condition received by the receiving section 46, and the specific image data whose image has been processed, the thumbnail, and the image forming condition are stored with them corresponding to each other. On this account, when the operator of the mobile terminal 2 additionally forms an image based on the specific image data whose image has been formed by setting the image forming condition for example, it is possible to send the thumbnail stored in the storage section 42. That is, a thumbnail is not newly generated, so that it is not necessary to perform an additional process, and it is possible to reduce a time taken to send the thumbnail to the mobile terminal 2.

It is more preferable to arrange the image forming control system according to the present invention so that the thumbnail generating section 44 generates a vector image as the thumbnail.

The vector image is a scalable image. The vector image has a smooth line no matter how the image is scaled up (the vector image seems not to vary even when the image is scaled up or scaled down), and its data amount does not so increase no matter how the image is scaled up. Examples of the vector image are: an image in compliance with SVG (Scalable Vector Graphics) standard; and an image in compliance with SVG-T standard; and the like. Further, in case of a JPEG format image, a GIF format image, and the like for example, when the image is scaled up, dots become rough which makes it hard to see the image. However, even when the vector image is scaled up, this does not result in such condition that it is hard to see the vector image.

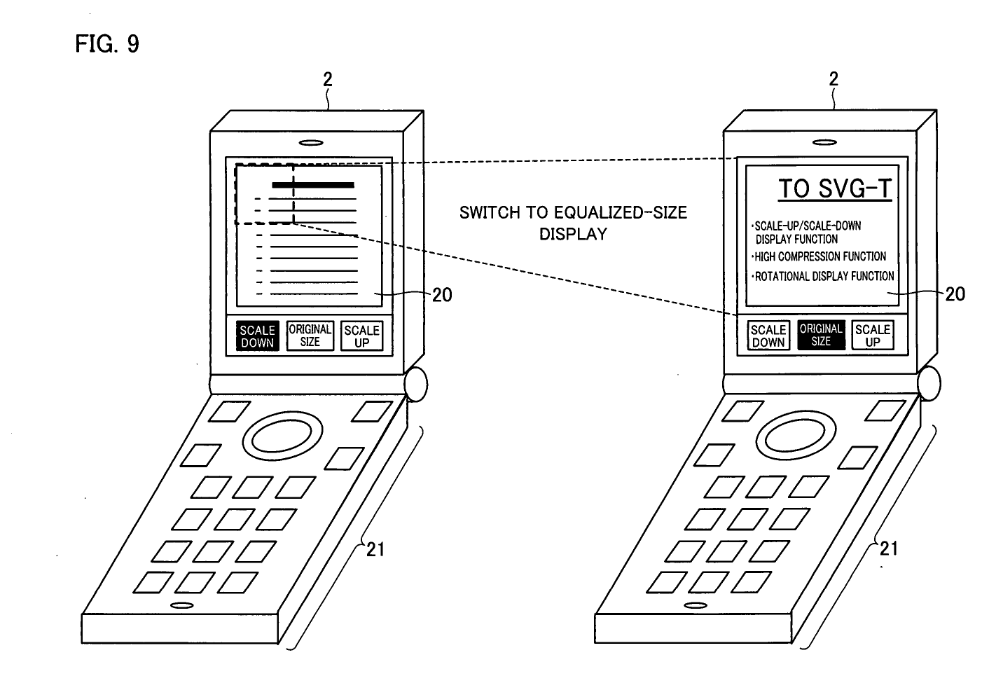

The SVG is a graphic data format defined by an international institute “W3C” for standardizing various Internet formats such as HTML. As in a vector font, the vector image based on the vector format has drawing information in such a manner that “a dot is placed in this point” and “a line is drawn from this point to that point”, so that it is possible to scale up/down and rotate the drawing smoothly. Thus, for example, as shown in FIG. 9, even when an entire image indicative of the entire specific image data is scaled up so as to be a full size (original size), it is possible to favorably recognize characters and drawings.

According to the foregoing arrangement, the thumbnail generating section 44 can generate the thumbnail which is a vector image. Thus, even when the mobile terminal 2 is a mobile terminal whose display screen is small for example, it is possible to make it easy to see the thumbnail.

Further, the mobile terminal 2 according to the present invention may be arranged so as to include: a terminal side communication section 23 (display image data receiving means) for receiving display image data from an image forming apparatus 1 or an image forming control system; and a condition setting section 52 (setting means) for setting an image forming condition under which there is formed an image based on specific image data used to generate the display image data having been received; wherein the terminal side communication section 23 (image forming condition sending means) is used to send the image forming condition, that has been set, to the image forming apparatus 1 or the image forming control system.

The image forming control device according to the present invention, which controls an image forming section 13 for forming an image based on image data in accordance with an image forming condition, includes: a sending section 47 for sending a thumbnail, generated in accordance with specific image data, whose information amount is smaller than the specific image data, to a mobile terminal 2; a receiving section 46 for receiving from the mobile terminal 2 the image forming condition under which an image based on the specific image data used to generate the thumbnail sent to the mobile terminal 2 is formed; and an image forming instruction section 43 for sending to the image forming section 13 an image forming instruction to form the image based on the specific image data in accordance with the image forming condition that has been received by the receiving section 46.

As described above, an image forming control method according to the present invention is a method for controlling an image forming section 13 which forms an image based on specific image data in accordance with an image forming condition received from a mobile terminal 2, and the method includes the steps of: sending a thumbnail, generated in accordance with the specific image data, whose information amount is smaller than the specific image data, to a mobile terminal 2; receiving from the mobile terminal 2 the image forming condition under which the image based on the specific image data is formed; and sending to the image forming section 13 an image forming instruction to form the image based on the specific image data in accordance with the image forming condition.

The image forming control system according to the present embodiment, in which an image forming apparatus and an external surrogate server are connected to each other via a network, may be arranged so that the image forming apparatus includes: means for acquiring original image data; means for sending the original image data to the external surrogate server; means for receiving a command, including a print order indicative of page count order information of original images, from an external device; means for editing the original images in an order based on the command that has been received; and means for performing image forming of image data obtained by editing the original images, and the external surrogate server includes: means for receiving the original image data from the image forming apparatus; means for generating thumbnails (display image data) of the original image data; and means for sending the thumbnails and the original images, which are to be displayed in the external device, to the external device with the thumbnails and the original images corresponding to each other. According to the foregoing arrangement, not the image forming apparatus but the communication device, such as a mobile phone, PDF, and a mobile computer, which is provided with communication means for communicating with the image forming apparatus, performs edition such as selection, sorting, and the like of print data, thereby reducing a time in which a main body is occupied and raising a usage rate of the image forming apparatus.

The image forming control device according to the present embodiment may be arranged so as to include: means for acquiring original image data (specific image data); means for generating thumbnails of the original image data; means for sending the thumbnails and page count information of original images to an external device with the thumbnails and the page count order information corresponding to each other; means for receiving a command, including a print order indicative of the page count order information of the original images, from the external device; means for editing the original images in an order based on the command that has been received; and means for performing image forming of image data obtained by editing the original images.

Further, the image forming control device according to the present embodiment may be arranged so as to include means for reserving the original image data, wherein when the command is received, the original image data that has been reserved is edited so as to perform image forming. According to the foregoing arrangement, it is possible to appropriate the original image data acquired (by means of a scanner or the like) so as to temporarily give the thumbnails and the page count order data to the external device, so that it is not necessary to additionally acquire the original image data for print output.

Further, the image forming control device according to the present embodiment may be arranged so as to be capable of selecting whether or not to reserve the original image data also after performing the image forming with edition corresponding to the command that has been received. According to the foregoing arrangement, the reserved original image data can be edited in the same manner or can be newly edited merely by sending the command from the external device, thereby realizing print output.

Further, the image forming control device according to the present embodiment may be arranged so that the thumbnail is a scalable image (like SVG-T). According to the foregoing arrangement, in case of specifying an output order by means of the external device such as a mobile phone, it is possible to freely confirm an entire layout or a minute character font by scaling up or scaling down the image.

Further, the image forming control device according to the present embodiment may be arranged so as to include means for sending print condition setting information to the external device, wherein the original images are edited so as to correspond to a command having a print condition received from the external device. According to the foregoing arrangement, it is possible to set a stapling process, a group-sorting process, a sheet size, a sheet direction, and the like.

The image forming apparatus according to the present embodiment may be arranged so as to include means for sending a condition setting program having print condition setting information to the external device, wherein the original images are edited so as to correspond to a command having a print condition received from the external device.

Further, the image forming control device according to the present embodiment may be arranged so as to scan print data (specific image data) from an image forming apparatus or obtain print data (specific image data) reserved in a reserving section of the image forming apparatus, and generate a thumbnail (and image information) in accordance with the specific image data, and send the thumbnail (and image information) to an external device (mobile terminal) via a radio line such as an infrared ray communication, Bluetooth (registered trademark), and the like, or a physical line such as a cable, and the like, and receive set-up (image forming condition) of the print data in the image forming apparatus which print data corresponds to the specific image data (print data) that has been set (edited) by the communication device, and give an instruction to carry out printing (carry out image forming).

Further, the image forming control device according to the present embodiment may be arranged so as to be capable of sending set-up information, indicative of stapling, group-sorting, and sheet size selection, which can be performed by the image forming apparatus, to the communication device as well as the thumbnail (and image information) of the specific image data, and be capable of receiving an image forming condition that has been edited in accordance with the set-up information.

Further, the image forming control device according to the present embodiment may be arranged so as to send set-up information corresponding to function information indicative of types and the like of the external devices.

Further, the method according to the present embodiment for controlling image forming may be arranged so as to include the steps of: generating thumbnails of original image data; sending the thumbnails and page count order information of original images to an external device with the thumbnails and the page count order information corresponding to each other; receiving a command, having a print order indicative of the page count order information of the original images, from the external device; editing the original image data in accordance with an order based on the command that has been received; and forming an image based on image data obtained by editing the original images.

Further, the image forming control method according to the present embodiment may be arranged so as to includes the step of reserving the original image data so as to receive a further command.

Further, the external device according to the present embodiment may be arranged so as to include: means for displaying a scalable thumbnail so as to correspond to a type (display resolution) of the external device itself; and means for receiving print condition setting information and a scale-up display instruction of the image forming apparatus, wherein when the scale-up display instruction is received, the display means displays the print condition that has been set and the scalable thumbnail whose size is the same as that of an image formed by the image forming apparatus. According to the foregoing arrangement, it is possible to confirm a size of a character or the like which is actually printed.

Further, the external device according to the present embodiment is arranged so that an image forming condition of the specific image data, in accordance with which the thumbnail has been generated, can be set in accordance with the thumbnail that has been received.

The external surrogate server (server) according to the present embodiment may be arranged so as to receive the print data (specific image data), reserved in the image forming apparatus, from the image forming apparatus, and obtain a thumbnail by compressively converting the specific image data, having been received, with the SVG-T technique, thereby sending the thumbnail to the external device.

Note that, the compressively converting function with the SVG-T technique may be given to any one of the image forming apparatus, the external device, and the external surrogate server, and any device may generate the thumbnail.

Lastly, each of the image forming apparatus 1 and the server 3, particularly the control section 10, may be constituted of hardware logic, or may be realized by software by using CPU as follows.

That is, each of the image forming apparatus 1 and the server 3 includes: CPU (central processing unit) for executing a command of a control program for realizing each function; ROM (read only memory) for storing the program; and a storage device (storage medium) such as a memory for storing the program and various kinds of data. Further, the object of the present invention can be achieved as follows: a storage medium for computer-readably storing a program code controlling each of the image forming apparatus 1 and the server 3 (an execute form program, intermediate code program, or source program) of software for implementing the aforementioned functions is provided to each of the image forming apparatus 1 and the server 3, and a computer (or CPU, MPU, and DSP) provided on each of the image forming apparatus 1 and the server 3 reads out the program code stored in the storage medium so as to implement the program, thereby achieving the object of the present invention.

Exemplified as the storage medium are: tapes, such as magnetic tape and cassette tape; disks including magnetic disks, such as floppy disks (registered trademark) and hard disk, and optical disks, such as CD-ROM/MO/MD/DVD/CD-R; cards, such as IC card (including memory cards) and optical cards; and semiconductor memories, such as mask ROMs, EPROMs, EEPROMs, and flash ROMs.

Further, it may be so arranged that: the image forming apparatus 1 and the server 3 can be connected to a communication network, and the program code is provided via the communication network. The communication network is not limited to a specific means. Specific examples of the communication network include Internet, intranet, LAN, ISDN, VAN, a CATV communication network, a virtual private network, a telephone line network, a mobile communication network, a satellite communication network, and the like. Further, a transmission medium constituting the communication network is not particularly limited. Specifically, it is possible to use a wired line such as a line in compliance with IEEE1394 standard, a USB line, a power line, a cable TV line, a telephone line, an ADSL line, and the like, as the transmission medium. Further, it is possible to use (i) a wireless line utilizing an infrared ray used in IrDA and a remote controller, (ii) a wireless line which is in compliance with Bluetooth standard (registered trademark) or IEEE802.11 wireless standard, and (iii) a wireless line utilizing HDR, a mobile phone network, a satellite line, a ground wave digital network, and the like, as the transmission medium. Note that, the program code can be realized as a computer data signal, realized by electronic transmission, which is embedded in a carrier wave.

In the present specification, means is not necessarily physical means, but a function of each means may be realized by software. Further, a function of a single means may be realized by two or more physical means, or functions of two or more means may be realized by a single physical means.

The image forming control system according to the present invention is applicable to an image forming system which uses a mobile terminal such as a mobile phone so as to send an image forming condition to an image forming apparatus.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An image forming control system, which controls an image forming section for forming an image based on image data in accordance with an image forming condition, comprising:
a sending section for sending display image data, generated in accordance with specific image data, whose information amount is smaller than the specific image data, to an external device;
a receiving section for receiving from the external device the image forming condition under which an image based on the specific image data is formed; and
an instruction section for sending to the image forming section an image forming instruction to form the image based on the specific image data in accordance with the image forming condition that has been received by the receiving section.

2. The image forming control system as set forth in claim 1, comprising:
an obtaining section for obtaining the specific image data; and
a generating section for generating a display image, whose information amount is smaller than the specific image data, in accordance with the specific image data that has been obtained.

3. The image forming control system as set forth in claim 1, comprising:
a storage device for storing the specific image data and the display image data which correspond to each other; and
a specifying section for specifying, among information stored in the storage device, the specific image data, whose image is to be formed under the image forming condition that has been received by the receiving section, in accordance with the image forming condition.

4. The image forming control system as set forth in claim 1, wherein
the instruction section sends the specific image data, whose image is to be formed, to the image forming section.

5. The image forming control system as set forth in claim 1, wherein
the sending section sends image information, concerning the specific image data, to the external device.

6. The image forming control system as set forth in claim 2, wherein:
when the generating section generates the display image data constituted of plural pages,
the sending section sends the display image data, constituted of plural pages, to the external device in a page count order in which the display image data has been generated by the generating section.

7. The image forming control system as set forth in claim 1, comprising a function obtaining section for obtaining function information concerning a function of the image forming section, wherein
the sending section sends the display image data and the function information to the external device.

8. The image forming control system as set forth in claim 1, comprising a storage device for storing information, wherein:
the instruction section causes the storage device to store the image forming condition, the specific image data, and the display image data, with the image forming condition, the specific image data, and the display image data corresponding to each other, and
when an image forming instruction to form the image based on the specific image data stored in the storage device is received from the external device, the sending section sends the display image data and the image forming condition, each of which corresponds to the specific image data, to the external device.

9. The image forming control system as set forth in claim 1, comprising an image processing section for processing the image based on the specific image data in accordance with the image forming condition, wherein
the instruction section causes the image processing section to process the image based on the specific image data in accordance with the image forming condition, and then sends the specific image data whose image has been processed and the image forming instruction to the image forming section.

10. The image forming control system as set forth in claim 2, comprising:
a storage device for storing information; and
an image processing section for processing the image based on the specific image data in accordance with the image forming condition, wherein:
the receiving section receives the image forming condition from the external device, and
the instruction section causes the generating section to generate the display image data of the specific image data whose image has been processed by the image processing section, and causes the storage device to store (i) the image forming condition, (ii) the specific image data whose image has been processed, and (iii) the display image data generated by the generating section, with the image forming condition, the specific image data, and the display image data corresponding to each other, and
when an image forming instruction to form an image based on the specific image data stored in the storage device is received from the external device, the sending section sends, from among information stored in the storage device, the display image data and the image forming condition, each of which corresponds to the image forming instruction, to the external device.

11. The image forming control system as set forth in claim 2, comprising:
a storage device for storing information; and
an image processing section for processing the image based on the specific image data in accordance with the image forming condition, wherein:
the receiving section receives from the external device the image forming condition and the display image data, sent from the sending section, whose image has been processed in accordance with the image forming condition, and
the instruction section causes the storage device to store (i) the display image data, received by the receiving section, whose image has been processed, (ii) the image forming condition, and (iii) the specific image data whose image has been processed by the image processing section, with the display image data, the image forming condition, and the specific image data corresponding to each other, and
when an image forming command to form the image based on the specific image data stored in the storage device is received from the external device, the sending section sends, from among information stored in the storage device, the display image data and the image forming condition, each of which corresponds to the image forming instruction, to the external device.

12. The image forming control system as set forth in claim 1, wherein the generating section generates a vector image as the display image data.

13. The image forming control system as set forth in claim 1, wherein the external device is a mobile terminal.

14. The image forming control system as set forth in claim 1, wherein the obtaining section is a scanner which obtains the specific image data by scanning a document.

15. An image forming apparatus, which forms an image based on image data in accordance with an image forming condition, comprising:
a sending section for sending display image data, generated in accordance with specific image data, whose information amount is smaller than the specific image data, to an external device;
a receiving section for receiving the image forming condition, under which an image based on the specific image data is formed, from the external device; and
an image forming section for forming the image based on the specific image data in accordance with the image forming condition.

16. The image forming apparatus as set forth in claim 15, comprising:
a scanner for obtaining the specific image data by scanning a document; and
a generating section for generating the display image data in accordance with the specific image data.

17. An external device, comprising:
a display image data receiving section for receiving display image data from an outside;
a setting section for setting an image forming condition under which there is formed an image based on specific image data used to generate the display image data having been received; and
an image forming condition sending section for sending the image forming condition, that has been set, to the outside.

18. An image forming control method, in which an image forming control system having a sending section, a receiving section, and an instruction section is controlled, comprising the steps of:
causing the sending section to send a display image, generated in accordance with specific image data, whose information amount is smaller than the specific image data, to an external device;
causing the receiving section to receive from the external device an image forming condition under which an image based on the specific image data is formed; and
causing the instruction section to send to an image forming section an image forming instruction to form the image based on the specific image data in accordance with the image forming condition.

19. An image forming control program, causing a computer to execute a function of each section included in the image forming control system as set forth in claim 1.

20. A computer-readable storage medium, storing an image forming control program which causes a computer to execute a function of each section included in the image forming control system as set forth in claim 1.
